(19) United States
(12) Patent Application Publication
(10) Pub. No.: US 2020/0279207 A1
(43) Pub. Date: Sep. 3, 2020

(54) SYSTEM AND METHOD FOR MANAGEMENT OF INTELLIGENCE REQUIREMENTS

(71) Applicant: D3 Intelligence LLC, Phoenix, AZ (US)

(72) Inventors: Brian Mohr, Phoenix, AZ (US); Walter Cook, Phoenix, AZ (US)

(21) Appl. No.: 16/803,891

(22) Filed: Feb. 27, 2020

Related U.S. Application Data
(60) Provisional application No. 62/812,089, filed on Feb. 28, 2019.

(51) Int. Cl. G06Q 10/06; H04L 29/06

(52) U.S. Cl. CPC G06Q 10/063114; H04L 63/1458; H04L 63/1425; G06Q 10/0633

(57) ABSTRACT

System and method for management of intelligence requirements according to various aspects of the present technology may comprise an intelligence requirement module configured to create one or more maps between a requirement library, an intelligence source library, and a customer library. The intelligence requirement module may interact with a workflow module having a user interface dashboard that allows users to create a workflow based on generated tickets corresponding to intelligence requirements and the intelligence source providing the information supporting the intelligence requirements. The workflow module may also generate reminders to facilitate the workflow and generate reports based on completed tasks.

### CROSS-REFERENCES TO RELATED APPLICATIONS

This application claims the benefit of U.S. Provisional Patent Application No. 62/812,089, filed Feb. 28, 2019, and incorporates the disclosure of the application by reference.

### BACKGROUND OF THE TECHNOLOGY

Intelligence teams have no efficient way of tracking requirements and often rely on manual tracking in a spreadsheet or with manually generated documents. In addition, supplier performance against requirements is often not formalized leaving intelligence teams without any quantifiable metrics for supplier review or performance against the desired requirements. The same is true for intelligence teams when measuring their own performance with respect to fulfilling their customers' requirements.

The result is that knowledge isn't captured in an organized or easily transferable manner creating inefficiencies and an inability to effectively track intelligence sources for cost and reliability over time. Management of intelligence sources becomes difficult since users of the provided information are unable to easily access historical data and performance details becomes tribalized. Further, intelligence professionals are often unable to easily document compliance with requirements or standards.

### SUMMARY OF THE TECHNOLOGY

System and method for management of intelligence requirements according to various aspects of the present technology may comprise an intelligence requirement module configured to create one or more maps between a requirement library, an intelligence source library, and a customer library. The intelligence requirement module may interact with a workflow module having a user interface dashboard that allows users to create a workflow based on generated tickets corresponding to intelligence requirements and the intelligence source providing the information supporting the intelligence requirements. The workflow module may also generate reminders to facilitate the workflow and generate reports based on completed tasks.

### BRIEF DESCRIPTION OF THE DRAWINGS

A more complete understanding of the present technology may be derived by referring to the detailed description and claims when considered in connection with the following illustrative figures. In the following figures, like reference numbers refer to similar elements and steps throughout the figures.

FIG. 1 representatively illustrates an initial mapping process in accordance with an exemplary embodiment of the present technology;

FIG. 2 representatively illustrates a process flow in accordance with an exemplary embodiment of the present technology;

FIG. 3 representatively illustrates a screen shot of a requirement library in accordance with an exemplary embodiment of the present technology;

FIG. 4 representatively illustrates a screen shot of a mapped intelligence source in accordance with an exemplary embodiment of the present technology;

FIG. 5 representatively illustrates a screen shot of an intelligence source in accordance with an exemplary embodiment of the present technology;

FIG. 6 representatively illustrates a screen shot of a mapped intelligence requirement to customer in accordance with an exemplary embodiment of the present technology;

FIG. 7 representatively illustrates a screen shot of an intelligence customer in accordance with an exemplary embodiment of the present technology;

FIG. 8 representatively illustrates a screen shot of a intelligence requirement to compliance map in accordance with an exemplary embodiment of the present technology;

FIG. 9 representatively illustrates a screen shot of an intelligence requirement to compliance map in accordance with an exemplary embodiment of the present technology;

FIG. 10 representatively illustrates a screen shot of threat category mapping in accordance with an exemplary embodiment of the present technology;

FIG. 11 representatively illustrates a screen shot of an intelligence requirement to threat map in accordance with an exemplary embodiment of the present technology;

FIG. 12 representatively illustrates a screen shot of a new ticket in accordance with an exemplary embodiment of the present technology;

FIG. 13 representatively illustrates a screen shot of suggested intelligence sources in accordance with an exemplary embodiment of the present technology;

FIG. 14 representatively illustrates a screen shot of available reports in accordance with an exemplary embodiment of the present technology;

FIG. 15 representatively illustrates a screen shot of an alternative report in accordance with an exemplary embodiment of the present technology;

FIG. 16 representatively illustrates a screen shot of suggested customers in accordance with an exemplary embodiment of the present technology;

FIG. 17 representatively illustrates a screen shot of feedback collection form in accordance with an exemplary embodiment of the present technology;

FIG. 18 representatively illustrates a screen shot of a user feedback collection form in accordance with an exemplary embodiment of the present technology;

FIG. 19 representatively illustrates a screen shot of a first set of performance metrics in accordance with an exemplary embodiment of the present technology; and

FIG. 20 representatively illustrates a screen shot of a second set of performance metrics in accordance with an exemplary embodiment of the present technology.

Elements and steps in the figures are illustrated for simplicity and clarity and have not necessarily been rendered according to any particular sequence. For example, steps that may be performed concurrently or in a different order are illustrated in the figures to help to improve understanding of embodiments of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various types of computing platforms, memory storage systems, and communication networks, which may carry out a variety of operations suited to processing various types of intelligence information. In addition, the embodiments described are merely exemplary applications for the technology. Further, the present technology may employ any number of conventional techniques for data storage and retrieval, reporting, or otherwise managing data.

System and method for management of intelligence requirements according to various aspects of the present technology may operate in conjunction with any type of computing system, application server, data storage system, or the like. Various representative implementations of the present technology may be applied to any system for managing intelligence information such as intelligence requirements, sources, assets, and/or the collection, mapping, and efficient use of these items.

The present technology may involve multiple programs, functions, computing devices (such as client computers and/or servers), and the like. While the exemplary embodiments are described in conjunction with conventional computing devices, the various elements and processes may be implemented in hardware, software, or any combination of hardware, software, and other systems. Further, the present technology may employ any number of conventional techniques for generating and/or analyzing intelligence information, interfacing a computing device to a network, transmitting and/or receiving data, providing a user interface, communicating information, interfacing with a user, detecting and/or analyzing input to a computing device, gathering data, and the like.

A user device may comprise conventional computing components, such as a processor, a local memory such as RAM, long term memory such as a hard disk, solid-state drive, or electronic non-volatile computer storage medium, a network adaptor, and any number of input and/or output devices such as a keyboard, mouse, monitor, touch screen, microphone, speaker, motion sensor, orientation sensor, light sensor, and the like. The various memories of the computing device may facilitate the storage of one or more computer instructions, such as a software routine and/or software program, which may be executable by the processor to perform one or more methods, processes, and/or steps of the disclosed technology. The computing device may comprise any suitable device or system such as: a personal computer, server, mobile phone, smart phone, tablet computer, kiosk, portable computer, and the like.

Further, databases, systems, and/or components of the present technology may comprise any combination of databases, systems, and/or components at a single location or at multiple locations. Each database, system, and/or component of the present technology may comprise any suitable security features, such as one or more firewalls, access codes, encryption, de-encryption, compression, decompression, and/or the like. Systems and methods according to the present technology may comprise one or more databases configured to store data according to the present technology. In some embodiments, data may be shared and/or linked among the various databases. The one or more databases may be implemented using database schemes such as IBM DB2, Oracle, MySQL, and/or Microsoft SQL Server, or any other database scheme, whether now known or later developed. Transferring data to and from the one or more databases may be accomplished using a communicative coupling, for example a network connection to the Internet or a local area network (LAN).

The present technology may be embodied as a method, a system, a device, and/or a computer program product. Accordingly, the present technology may take the form of an entirely software embodiment, an entirely hardware embodiment, or an embodiment combining aspects of both software and hardware. Furthermore, the present technology may take the form of a set of instructions, such as a computer program product, for causing a processor and/or computing device to perform a desired function, stored on a non-transitory computer-readable storage medium having computer-readable program code embodied in the storage medium. Any suitable computer-readable storage medium may be utilized, including, but not limited to, hard disk drive, CD-ROM, optical storage devices, magnetic storage devices, USB memory devices, any appropriate volatile or non-volatile memory system, and the like or any combination thereof. The present technology may take the form of a downloadable and/or cloud-based non-downloadable computer program product and/or methods.

Software and/or software elements according to various aspects of the present technology may be implemented with any programming, scripting, or computer language or standard, such as, for example, AJAX, C, C++, Java, JavaScript, COBOL, assembly, PERL, eXtensible Markup Language (XML), PHP, CSS, HL7, GNU Mathematical Programming Language (GMPL), etc., or any other programming and/or scripting language, whether now known or later developed. Further, the present technology may be used in conjunction with a computing device running any operating system such as any version of Windows, MacOS, OS/2, BeOS, Linux, UNIX, Android, iOS, or any other operating system, whether now known or later developed, and the present technology may be used in conjunction with any software application operating on such a computing device.

In addition, the present technology may employ any number of conventional techniques for data transmission, signaling, data processing, network control, and the like. Computing devices according to various aspects of the present technology may communicate with each other by one or more telecommunication networks. The telecommunication network may comprise a collection of terminal nodes, links, and any intermediate nodes which are connected to enable communication (including transfer of data) at a distance between the terminal nodes. In some embodiments, a terminal node may comprise a computing device. The telecommunication network may comprise any suitable communication system, such as the Internet, an intranet, an extranet, WAN, LAN, satellite communications, cellular radio network, wireless network, telephone network, cable network, and the like. Moreover, computing devices according to various aspects of the present technology may communicate over the telecommunication network using TCP/IP, HTTP, HTTPS, FTP, IPX, AppleTalk, IP-6, NetBIOS, OSI, and/or any number of existing or future protocols. The telecommunication network may be simply referred to as a network.

Referring now to FIG. 1, an intelligence requirement mapping and workflow tracking system may comprise an intelligence requirement module 100 configured to create at least one intelligence map according to a set of intelligence requirements and a group of intelligence sources capable of providing information, answers, or solutions to the intelligence requirements. The intelligence requirement module 100 may be configured to generate one or more mappings automatically or assist one or more users to generate the map. In one embodiment, the system may collect data from an intelligence team (110) or customers (120) and present the data to the user to facilitate the mapping of intelligence requirements for each customer (130). The mapping process may create links between similar requirements that can be leveraged by the system during planning, assigning, and reporting phases conducted later in a workflow process. For example, the mapping process may indicate that a given intelligence requirement is shared among multiple customers or can be provided by multiple intelligence sources. This overlapping of requirements may be recognized and used by the system to prevent redundant work, increase efficiency, ensure compliance, or compare performance of intelligence sources against one another.

The intelligence requirement module 100 may comprise a requirements library configured to store identified intelligence requirements. An intelligence requirement comprises any question or informational need that is required for a user of the intelligence requirement to make a decision based on the intelligence question. The requirements library may comprise any suitable information relating to the intelligence requirements such as a standard, government policy, geographic data, geo-political data, environmental data, tactical data, or the like. The requirements library may also include threat data and any requirements that may relate to a given threat.

The intelligence requirement module 100 may also comprise an intelligence source library configured to store intelligence sources available to provide the information for a given intelligence requirement. An intelligence source may comprise any suitable person, entity, document, periodical, source, or method capable of providing the necessary information to satisfy one or more intelligence requirements.

After the intelligence requirements have been identified, the intelligence requirement module 100 may engage in a second mapping process to analyze each intelligence requirement and assign or identify at least one intelligence source to provide the necessary information to meet the need of a given intelligence requirement (140). Identified intelligence sources may comprise any suitable method, system, or device for observing, collecting, and recording information pertaining to the corresponding intelligence requirement. For example, the intelligence requirement module 100 may be configured to distinguish between internal and external (third party) intelligence sources that are capable of fulfilling one or more intelligence requirements and provide details of a given intelligence source according to any suitable criteria such as: which intelligence requirements a given intelligence source provides, cost, regulatory requirements, customer requirements, or the like. The mapping process may also allow users to more quickly identify providers of the required intelligence source(s) or determine if there are any gaps or disconnects between intelligence sources and intelligence requirements.

Mappings may be saved by the intelligence requirement module 100 to improve and preserve historical knowledge of intelligence requirements and the intelligence sources that are able to meet the requirements. Various maps may also be ranked or otherwise provided with one or more indicator to highlight various factors or considerations such as: to identify a preferred intelligence source over another option, to provide an indication that one intelligence source may be preferred over another in a given circumstance, that one intelligence source may provide the same solution for a lower cost, when one intelligence source isn't being used to its full capability or contracted ability, or the like. Mappings may also include details on factors such as reliability, timeliness, cost, status as an approved vendor, and performance of each intelligence source.

The intelligence requirement module 100 may also be configured to help identify intelligence gaps. For example, an incomplete mapping may indicate an intelligence requirement with no identified intelligence source. This information provides users of the system with an early indication that an intelligence source and/or provider would need to be identified or the intelligence requirement may not be fulfilled adequately or on time. Similarly, a mapping may indicate that one or more intelligence requirements are stored within the system and are not matched to a customer. This may be indicative of inefficiencies within the workflow system or that unnecessary work is being performed.

The intelligence requirement module 100 may further comprise a risk library. The risk library provides a link between an identified risk and/or compliance requirement and which intelligence requirements may be used to demonstrate compliance. This link may be included in at least one of the mappings to allow users to more easily understand and track which elements of risk are met by intelligence requirements or when a gap between a needed compliance factor and a lack of an intelligence source capable of addressing that factor exists. This early identification offers users the ability to take action early in the workflow to address issues before they impact the scheduled workflow deadline.

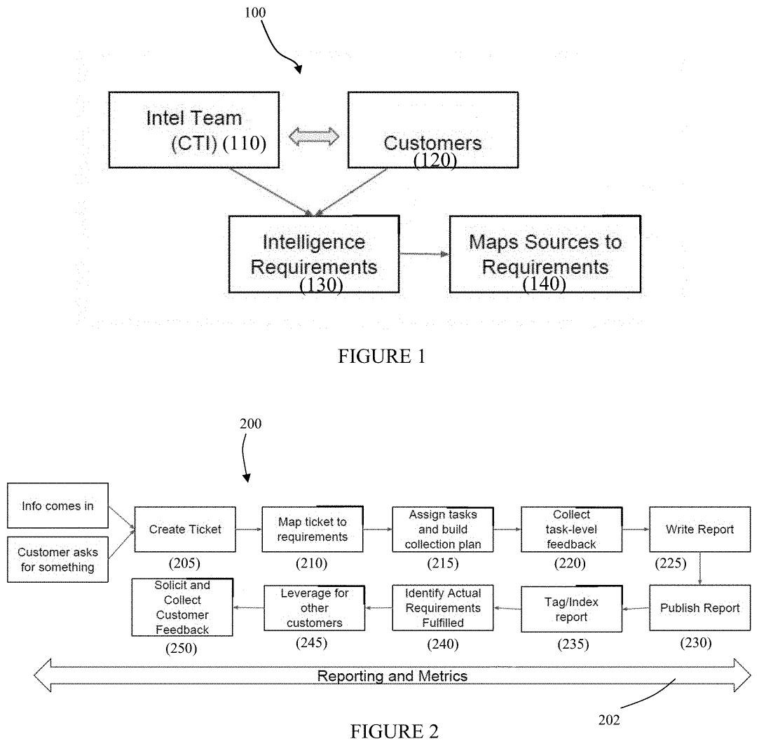

The intelligence requirement mapping and workflow tracking system may also comprise a workflow module 200 configured to manage incoming information and/or customer requests according to the mappings from the intelligence requirement module 100. In one embodiment, and referring now to FIG. 2, the workflow module 200 may be configured to create one or more tickets, or workflows, according to received work requests, customer deliverables, intelligence providers, and the like (205). The workflow module 200 may comprise a user interface, or dashboard, communicatively linked to the intelligence requirement module 100. The dashboard may allow a user to map created tickets against the mappings generated by the intelligence requirement mapping module 100 to link a customer's needs to corresponding intelligence requirement(s) (210).

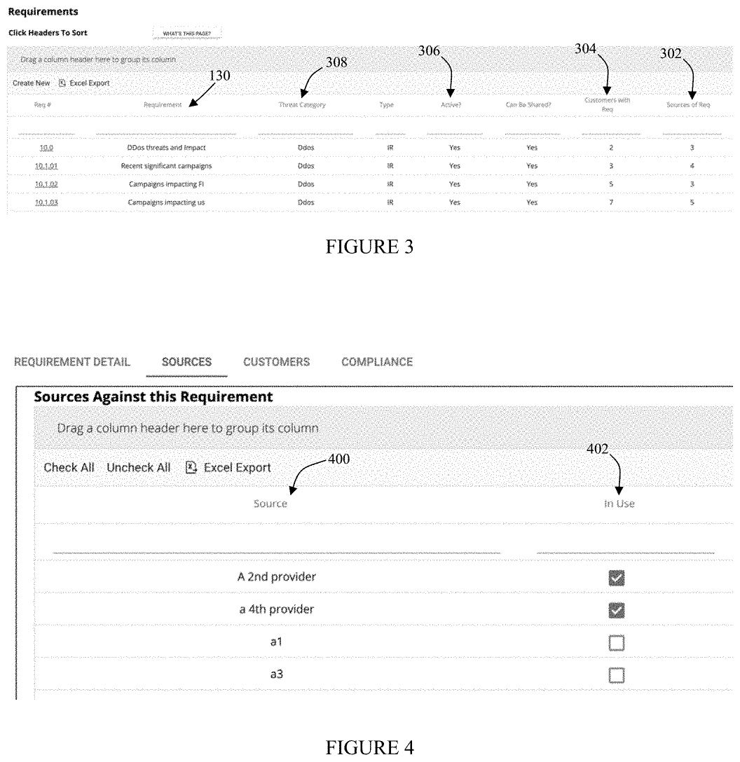

For example, referring now to FIG. 3, the dashboard may allow the user to access the requirements library to review identified intelligence requirements 130 or determine when a new intelligence requirement 130 is required. The user may be able to locate specific intelligence requirements 130 and any associated details such as how many intelligence sources 302 can meet each intelligence requirement 130, how many customers 304 use a particular intelligence requirement 130, the status 306 of the intelligence requirement 130, and whether or not a particular threat 308 is applicable to the intelligence requirement 130. The dashboard may allow the various categories to be filtered or sorted to assist the user with selecting appropriate intelligence requirements 130 for a given ticket.

Referring now to FIG. 4, clicking on a given listing of intelligence sources 302 for a given intelligence requirement 130 may allow the user to access a screen showing the specific intelligence sources 400 that correspond to the intelligence requirement 130. The screen may show whether or not each intelligence source 400 is currently being used 402 by the intelligence requirement mapping and workflow tracking system to meet the intelligence requirement 130.

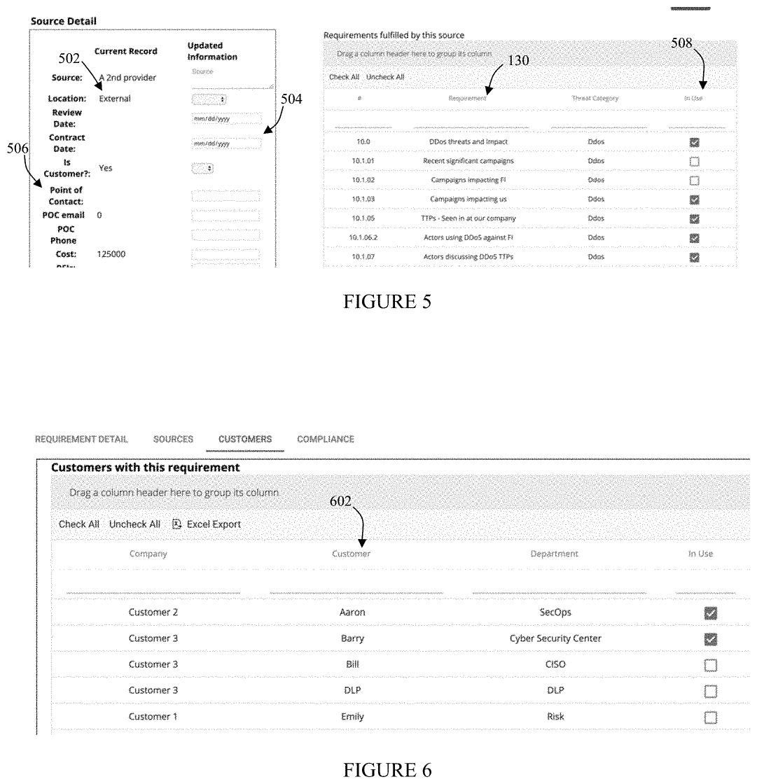

Now referring to FIG. 5, the dashboard may also allow the user to review each intelligence source 400 to determine specific details for the intelligence source 400 such as: whether or not the intelligence source 400 is internal or external 502, a status of the intelligence source 504, contact information 506, and which additional intelligence requirements 130 can be provided. The screen may also provide insight into whether or not the intelligence source 400 is actually being used to provide all of the available intelligence requirements 508 that the intelligence source 400 is able to provide.

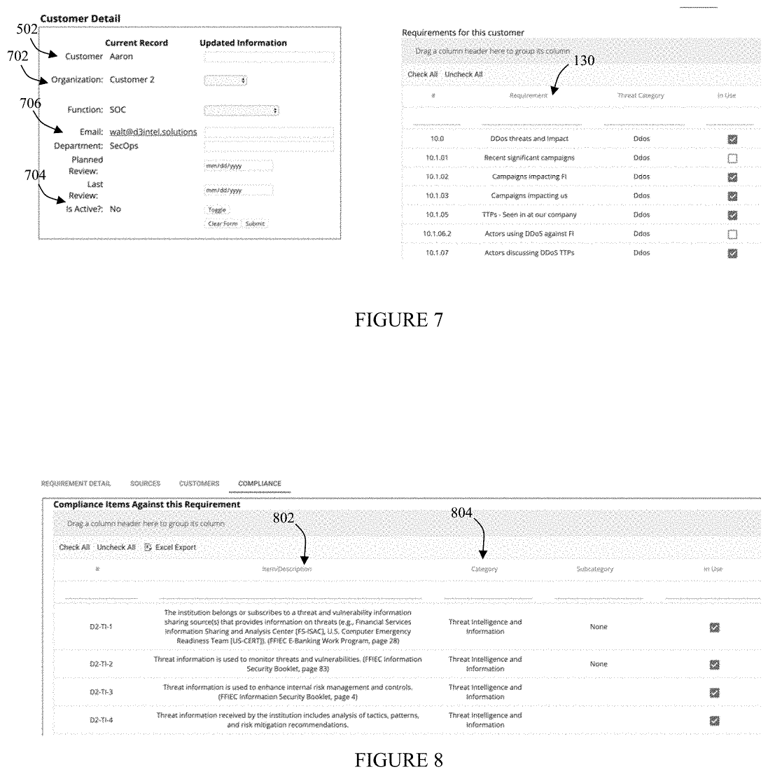

As shown in FIGS. 6 and 7, the dashboard may be configured to show the user which customers 602 use a given intelligence requirement 130. If a user clicks on a given customer 602, the dashboard may display detailed information for that customer such as: whether or not the customer is internal or external 702, a status of the customer 704, contact information 706, and other intelligence requirements 130 provided to that customer.

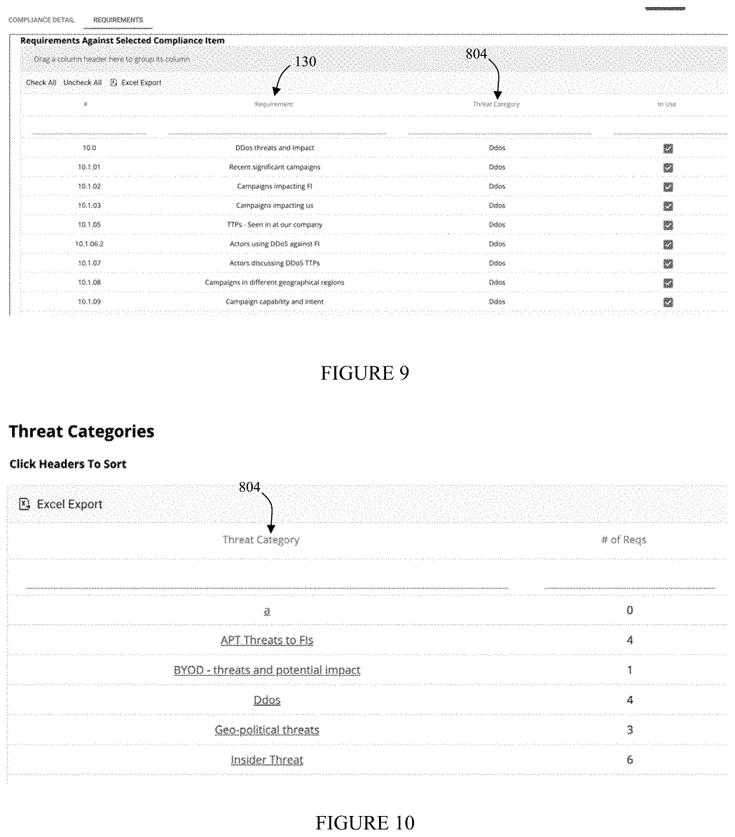

Referring now to FIG. 8, the user may also be able to view a compliance screen to view specific threats 802 that are mapped to a particular intelligence requirement 130 and which category 804 each threat may be contained within. Similarly, as shown in FIG. 9, the user may be able to access a screen showing intelligence requirements 130 that are mapped against a given compliance item. The dashboard may also allow the user to view individual threat categories 804. As shown in FIG. 10, threats may be mapped against intelligence requirements 130 to show how many intelligence requirements 130 are associated with a particular threat category 804.

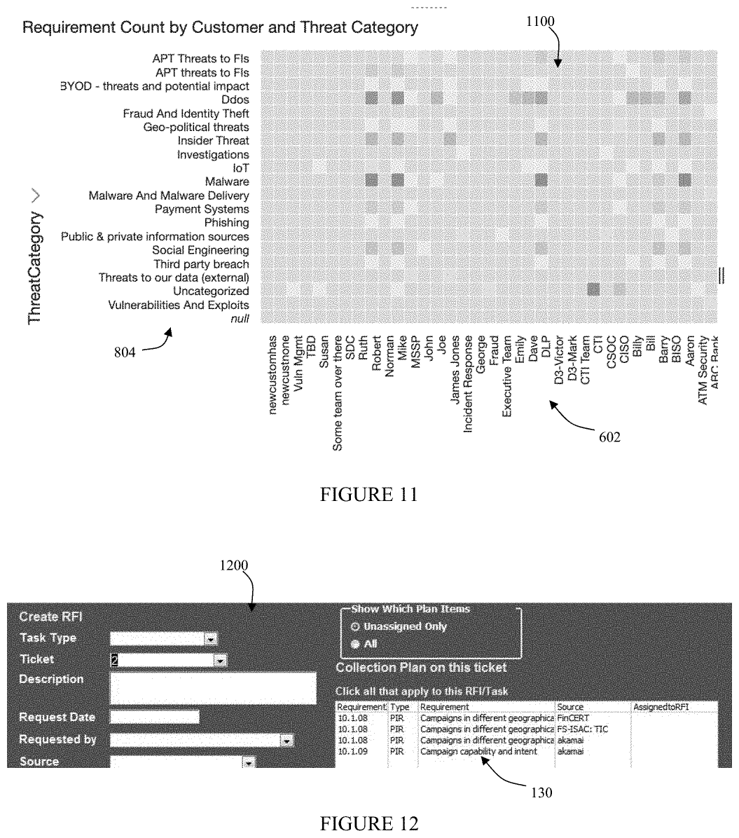

Referring now to FIG. 11, the workflow module 200 may also be configured to provide a visual indication of threats. For example, in one embodiment, the user may be able to select to view a heat map 1100 comparing categories of threats 804 against customers 602. This view provides an easy-to-read visual of areas of requirements focus and potential opportunity for requirements expansion into different threats 804 and/or customers 602.

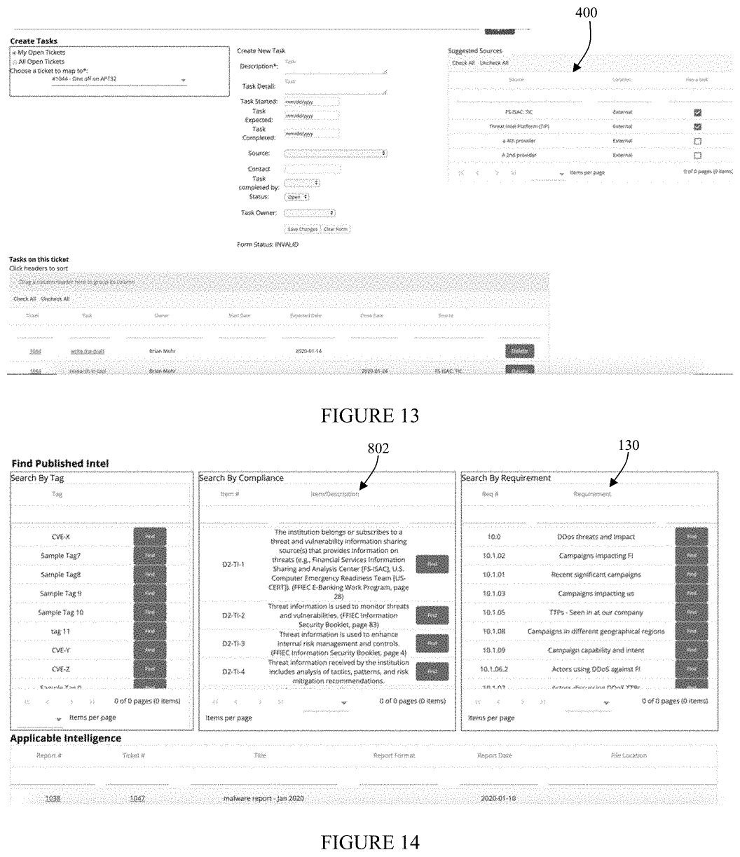

Referring now to FIGS. 12 and 13, the user may use the dashboard to create a ticket 1200 by selecting specific intelligence requirements 130 associated with the ticket 1200. The dashboard may also allow the user to select intelligence sources 400 that can meet the selected intelligence requirements 130.

Referring again to FIG. 2, once the user has created at least one ticket 1200 (210), the workflow module 200 is able to generate a plan for fulfilling the customer requests and assign specific tasks according to the plan (215). The workflow module 200 may also be configured to monitor the progress of assigned tasks (220). For example, the workflow module 200 may be configured to track dates relating to expected completion dates for a given task or subtask and identity a point of contact for each task.

As tasks are completed, the user may be able to use the dashboard to update the status of each ticket. For each completed ticket, the workflow module 200 may be configured to generate and publish one or more reports (225), (230), (235), (240). The reports may comprise any suitable information or be directed to a desired outcome. For example, reports may be generated for each assigned task and corresponding intelligence requirement 130 to provide greater insight into whether or not an identified intelligence requirement 130 is being met according to the plan. The reports may also be used to help generate metrics (202) for evaluating performance, fulfillment, user feedback, or any other data that can be used to monitor a performance level of the system. Reports may also be generated as a deliverable for a given ticket according to the customer/intelligence requirements.

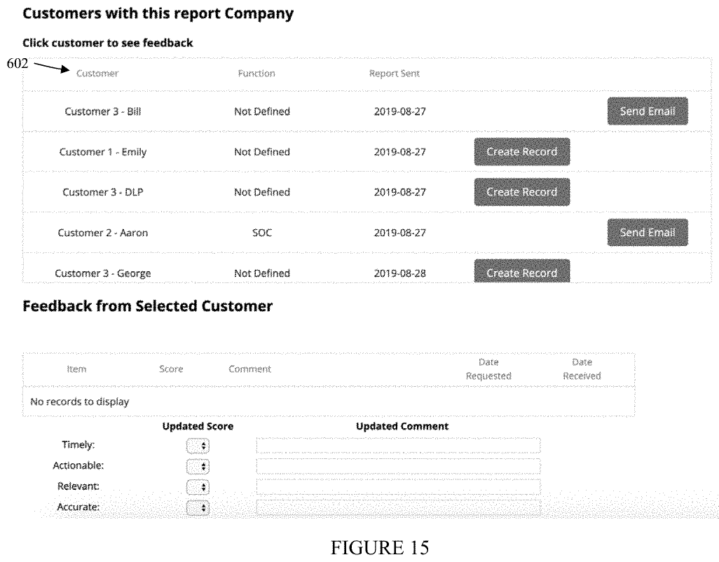

For example, referring now to FIGS. 14 and 15, the user may be able to search for generated reports by any suitable criteria such as by intelligence requirement 130, compliance requirement, assigned task, or by individual ticket. Alternatively, reports may be searchable by customers 602 or show when a given report was sent to a customer 602. If the customer 602 hasn't received the report, the user may select to send the report to the customer 602 in response to an assigned task.

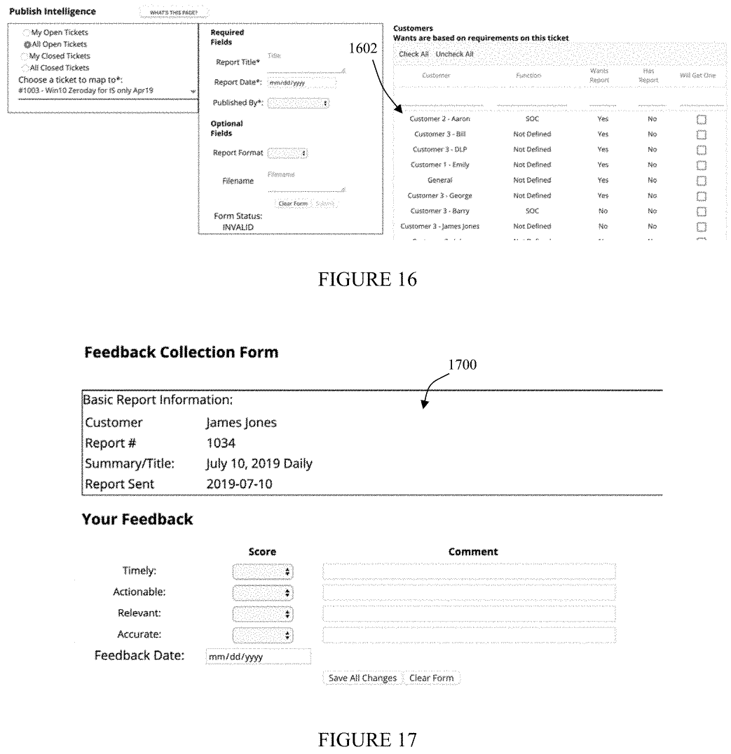

Referring now to FIG. 16, the workflow module 200 may also be configured to analyze the generated reports to determine if the information contained in a given report may be useful to additional customers 1602 or sources of intelligence 400 (245). In this way, the workflow module 200 is able to leverage generated information to proactively improve the way in which information is used by customers 602 (both internal and external), intelligence sources 400, and parties performing the generated tasks. The dashboard may allow the user select which additional customers 1602 receive the report and avoid sending out reports to customers who don't use a particular intelligence requirement. This improves the efficacy of the reports by only sending them to those customers 602 that are interested in the information.

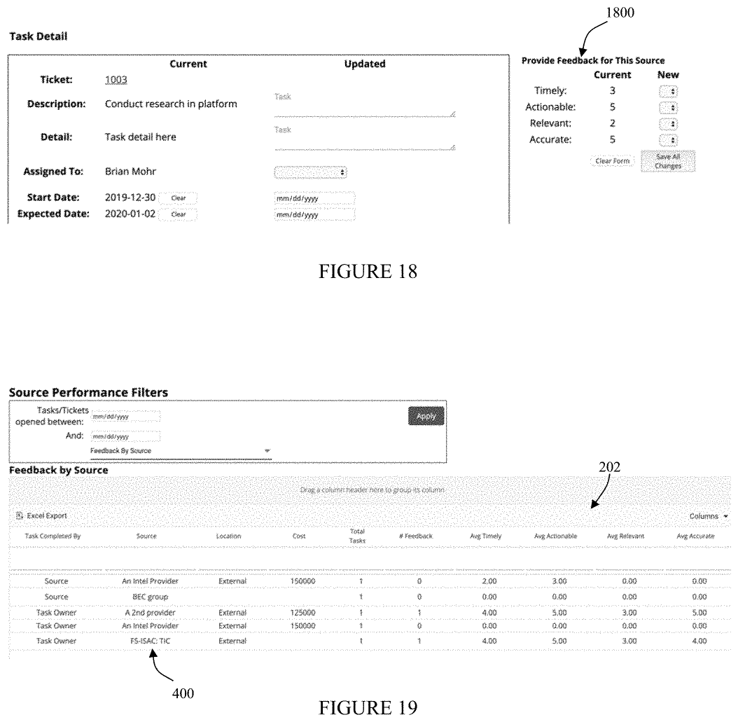

Referring again to FIG. 2, the workflow module 200 may further be configured to receive feedback from one or more sources (250) at any point in the workflow process. For example, in one embodiment, the workflow module 200 may prompt a customer 602 to respond to a survey or otherwise provide feedback on any suitable criteria such as timeliness, quality, or efficacy. For example, referring to FIG. 17, a customer 602 may receive a feedback form 1700 or a link to a fillable form via email from the workflow module 200. Responses received from the customer 602 may be saved and entered into a performance evaluation module or feedback library. The workflow module 200 may also be configured to prompt the user to provide feedback 1800 during or following the completion of individual tasks or tickets within the workflow as shown in FIG. 18.

The workflow module 200 may also be configured to audit the feedback process to ensure that received inputs from the one or more sources are being reviewed or incorporated back into the workflow process. For example, feedback received from any source may be processed and displayed to the user to provide additional qualitative analysis. Metrics 202 may be generated according to any suitable criteria such as: at the task level; source level; quality of intelligence; actual requirements; or the like.

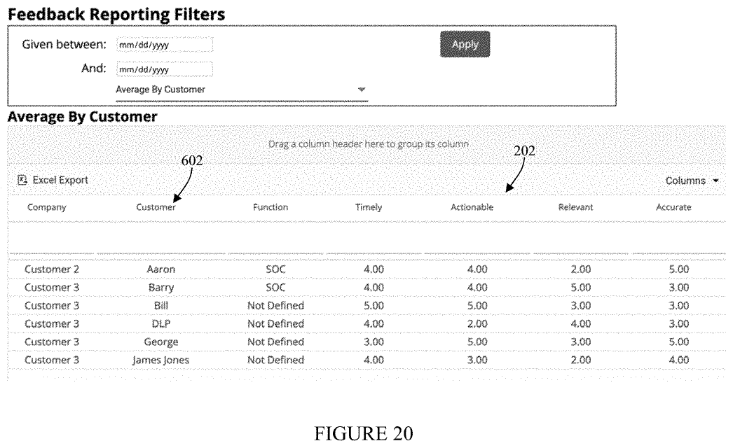

For example, FIG. 19 displays performance ratings for individual intelligence sources 400. The ratings may cover any suitable criteria for allowing users to evaluate intelligence sources 400 for factors such as cost, accuracy, timeliness, and number of feedback responses received. Similarly, and referring now to FIG. 20, the workflow module 200 may provide data on intelligence sources 400 from the customer perspective.

A given workflow, ticket, task, or report is often created for a single customer 602. It is known, however, that individual customers often have the same intelligence requirements as other customers and could benefit from the knowledge provided to those other customers. The workflow module 200 may allow individual customers to share data or reports with each other through an opt in or collaboration feature within the workflow module 200. This may allow customers to take advantage of redundancies or spread costs to increase efficiencies of intelligence workflows. Alternatively, a given customer may choose to hold back certain reports from other customers that are competitors when the data contained within the report is considered proprietary or a trade secret.

These and other embodiments for an intelligence requirement mapping and workflow tracking system may incorporate concepts, embodiments, and configurations as described above. The particular implementations shown and described are illustrative of the technology and its best mode and are not intended to otherwise limit the scope of the present technology in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the components and/or elements recited in any apparatus embodiment may be assembled or otherwise operationally configured in a variety of permutations to produce substantially the same result as the present technology and are accordingly not limited to the specific configuration recited in the specific examples.

As used herein, the terms “comprises,” “comprising,” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same.

The present technology has been described above with reference to exemplary embodiments. However, changes and modifications may be made to the exemplary embodiments without departing from the scope of the present technology. These and other changes or modifications are intended to be included within the scope of the present technology, as expressed in the following claims.

1. An intelligence requirement mapping and workflow tracking system, comprising:
an intelligence requirement module comprising:
a requirements library;
an intelligence source library; and
a customer library,
wherein the intelligence requirement module is configured to:
create a map identifying each intelligence source within the intelligence source library capable of meeting at least one intelligence requirement within the requirements library; and
create a second map linking at least one intelligence requirement with each customer within the customer library;
a workflow module comprising a dashboard communicatively linked to the intelligence requirement module configured to:
allow a user to create at least one ticket for a customer by selecting:
a set of intelligence requirements from the requirements library; and
a set of intelligence sources from the mapped intelligence sources corresponding to the selected intelligence requirements;
generate a plan for fulfilling the set of intelligence requirements for each ticket by creating one or more tasks;
manage incoming information according to the tasks; and
monitor the progress of the tasks.

2. An intelligence requirement mapping and workflow tracking system according to claim 1, wherein the workflow module is configured to generate a report for the customer based on the fulfilled set of identified intelligence requirements from the plan.

3. An intelligence requirement mapping and workflow tracking system according to claim 2, wherein the workflow module is configured to receive customer feedback relating to the generated report.

4. An intelligence requirement mapping and workflow tracking system according to claim 2, wherein the workflow module is further configured to forward the generated report to one or more additional customers identified in the second map having a history of similar identified intelligence requirements.

5. An intelligence requirement mapping and workflow tracking system according to claim 1, wherein the dashboard is further configured to display all intelligence requirements provided by a given intelligence source.

6. An intelligence requirement mapping and workflow tracking system according to claim 1, wherein the dashboard is further configured to display all customers having a given intelligence requirement.

7. An intelligence requirement mapping and workflow tracking system according to claim 1, wherein:
the intelligence requirement module further comprises a risk library linking a required compliance metric with at least one intelligence requirement; and
the workflow module is configured to generate a compliance report according to the generated plan for any task having an intelligence requirement linked to the risk library.

8. An intelligence requirement mapping and workflow tracking system according to claim 1, wherein:
the requirements library further comprises threat information for each intelligence requirement; and
the workflow module is configured to:
allow the user to assign a threat category to a given intelligence requirement within the requirements library;
display to the user a summary of intelligence requirements and their corresponding threats; and
allow the user to close tickets associated with a threat to indicate compliance.

9. An intelligence requirement mapping and workflow tracking system according to claim 8, wherein the workflow module is configured to display a heat map of customer intelligence requirements and corresponding threats.

10. An intelligence requirement mapping and workflow tracking system according to claim 1, wherein the workflow module is configured to generate task reminders.

11. An intelligence requirement mapping and workflow tracking system according to claim 1, wherein the workflow module is configured to receive user feedback relating to a performance of a selected intelligence source for a given task.

12. An internet-based intelligence requirement mapping and workflow tracking system accessible by a user device connected to the internet via a network, comprising:
an intelligence requirement module, comprising:
a requirements library;
an intelligence source library; and
a customer library,
wherein the intelligence requirement module is configured to:
create a map identifying each intelligence source within the intelligence source library capable of meeting at least one intelligence requirement within the requirements library; and
create a second map linking at least one intelligence requirement with each customer within the customer library;
a workflow module comprising a dashboard communicatively linked to the intelligence requirement module and the user device and configured to:
allow a user to create at least one ticket for a customer by selecting:
a set of intelligence requirements from the requirements library; and
a set of intelligence sources from the mapped intelligence sources corresponding to the selected intelligence requirements;
generate a plan for fulfilling the set of intelligence requirements for each ticket by creating one or more tasks;
manage incoming information according to the tasks; and
monitor the progress of the tasks.

13. An internet-based intelligence requirement mapping and workflow tracking system according to claim 12, wherein the workflow module is configured to generate a report for the customer based on the fulfilled set of identified intelligence requirements from the plan.

14. An internet-based intelligence requirement mapping and workflow tracking system according to claim 13, wherein the workflow module is configured to receive customer feedback relating to the generated report.

15. An internet-based intelligence requirement mapping and workflow tracking system according to claim 13, wherein the workflow module is further configured to forward the generated report to one or more additional customers identified in the second map having a history of similar identified intelligence requirements.

16. An internet-based intelligence requirement mapping and workflow tracking system according to claim 12, wherein the dashboard is further configured to display all intelligence requirements provided by a given intelligence source.

17. An internet-based intelligence requirement mapping and workflow tracking system according to claim 12, wherein the dashboard is further configured to display all customers having a given intelligence requirement.

18. An internet-based intelligence requirement mapping and workflow tracking system according to claim 12, wherein:
the intelligence requirement module further comprises a risk library linking a required compliance metric with at least one intelligence requirement; and
the workflow module is configured to generate a compliance report according to the generated plan for any task having an intelligence requirement linked to the risk library.

19. An internet-based intelligence requirement mapping and workflow tracking system according to claim 12, wherein:
the requirements library further comprises threat information for each intelligence requirement; and
the workflow module is configured to:
allow the user to assign a threat category to a given intelligence requirement within the requirements library;
display to the user a summary of intelligence requirements and their corresponding threats; and
allow the user to close tickets associated with a threat to indicate compliance.

20. An intelligence requirement mapping and workflow tracking system according to claim 19, wherein the workflow module is configured to display a heat map of customer intelligence requirements and corresponding threats.

21. An intelligence requirement mapping and workflow tracking system according to claim 12, wherein the workflow module is configured to generate task reminders.

22. An intelligence requirement mapping and workflow tracking system according to claim 12, wherein the workflow module is configured to receive user feedback relating to a performance of a selected intelligence source for a given task.
